(19) United States
(12) Patent Application Publication
(10) Pub. No.: US 2025/0212141 A1
(43) Pub. Date: Jun. 26, 2025

(54) TIME ADVERTISEMENT IN WIRELESS NETWORKS

(71) Applicant: Cisco Technology, Inc., San Jose, CA (US)

(72) Inventors: Alan W. DUMDEI, Greenville, TX (US); Matthew A. SILVERMAN, Shaker Heights, OH (US); Jerome HENRY, Pittsboro, NC (US); Malcolm M. SMITH, Richardson, TX (US); Peiman AMINI, Fremont, CA (US); Ardalan ALIZADEH, Campbell, CA (US)

(21) Appl. No.: 18/589,290

(22) Filed: Feb. 27, 2024

Related U.S. Application Data
(60) Provisional application No. 63/614,514, filed on Dec. 22, 2023.

(51) Int. Cl. H04W 56/00

(52) U.S. Cl. CPC H04W 56/001

(57) ABSTRACT

The present disclosure describes a wireless network in which access points and devices can signal their timing capabilities. An apparatus includes one or more memories and one or more processors communicatively coupled to the one or more memories. A combination of the one or more processors determines a time value and generates a message that includes a first field and a second field. The first field uses a first set of bits to indicate seconds of the time value and a second set of bits to indicate fractions of seconds of the time value. The second field indicates an accuracy range of the determined time value. The combination of the one or more processors also wirelessly transmits the message.

### CROSS-REFERENCE TO RELATED APPLICATIONS

This application claims benefit of co-pending U.S. provisional patent application Ser. No. 63/614,514 filed Dec. 22, 2023. The aforementioned related patent application is herein incorporated by reference in its entirety.

### TECHNICAL FIELD

Embodiments presented in this disclosure generally relate to wireless communication. More specifically, embodiments disclosed herein relate to time advertisement in wireless networks (e.g., wireless fidelity (WiFi) networks).

### BACKGROUND

Existing wireless networks synchronize the clocks in the devices on the networks, including mobile devices and access points. These synchronization processes may provide synchronization in the microsecond (μs) range. As wireless networks have advanced, the synchronization demands have increased. For example, some networks may require synchronization that is less than one μs.

Various ranging protocols may be used by existing wireless networks (e.g., fine timing measurement (FTM) and ultra-wideband (UWB)) to achieve synchronization that is less than one μs. Existing networks, however, may not be able to determine what type of synchronization a device implements or what timing accuracy the device is capable of providing. As a result, the networks may also not know how to initiate a session with the device to perform synchronization.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A and 1B illustrate an example system.

FIG. 2 illustrates an example operation performed by the system of FIG. 1A.

FIG. 3 illustrates an example message in the system of FIG. 1A.

FIG. 4 illustrates an example time value in the system of FIG. 1A.

FIG. 5 illustrates an example table in the system of FIG. 1A.

FIG. 6 illustrates an example message in the system of FIG. 1A.

FIG. 7 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a wireless network in which access points and devices can signal their timing capabilities. According to an embodiment, an apparatus includes one or more memories and one or more processors communicatively coupled to the one or more memories. A combination of the one or more processors determines a time value and generates a message that includes a first field and a second field. The first field uses a first set of bits to indicate seconds of the time value and a second set of bits to indicate fractions of seconds of the time value. The second field indicates an accuracy range of the determined time value. The combination of the one or more processors also wirelessly transmits the message.

According to another embodiment, a method includes determining a time value and generating a message that includes a first field and a second field. The first field uses a first set of bits to indicate seconds of the time value and a second set of bits to indicate fractions of seconds of the time value. The second field indicates an accuracy range of the determined time value. The method also includes wirelessly transmitting the message.

According to another embodiment, an apparatus includes one or more memories and one or more processors communicatively coupled to the one or more memories. A combination of the one or more processors determines a time value and determines an accuracy range for the time value. The combination of the one or more processors also determines, based on a table, an accuracy field value for the accuracy range and generates a message that includes a first set of bits and a second set of bits indicating the time value. The message also includes a timing capabilities field value indicating that the first set of bits indicates seconds of the time value and that the second set of bits indicates fractions of seconds of the time value. The message further includes the accuracy field value. The combination of the one or more processors also wirelessly transmits the message.

### EXAMPLE EMBODIMENTS

The present disclosure describes a wireless network (e.g., a WiFi network) in which devices (e.g., mobile devices and access points) can signal their timing capabilities. Generally, each device may use an internal clock to determine a time value within a certain accuracy range. The device may then generate a message to report the time value and the accuracy range. The message may use a set of bits to indicate the seconds of the time value and another set of bits to indicate fractions of seconds of the time value. The device may then transmit the message to let other devices in the network know of the device's timing capabilities.

In certain embodiments, the devices (e.g., access points) on the network may determine the timing capabilities and timing accuracy of the other devices on the network. The devices may also determine how to initiate sessions with the other devices to perform timing processes (e.g., synchronization).

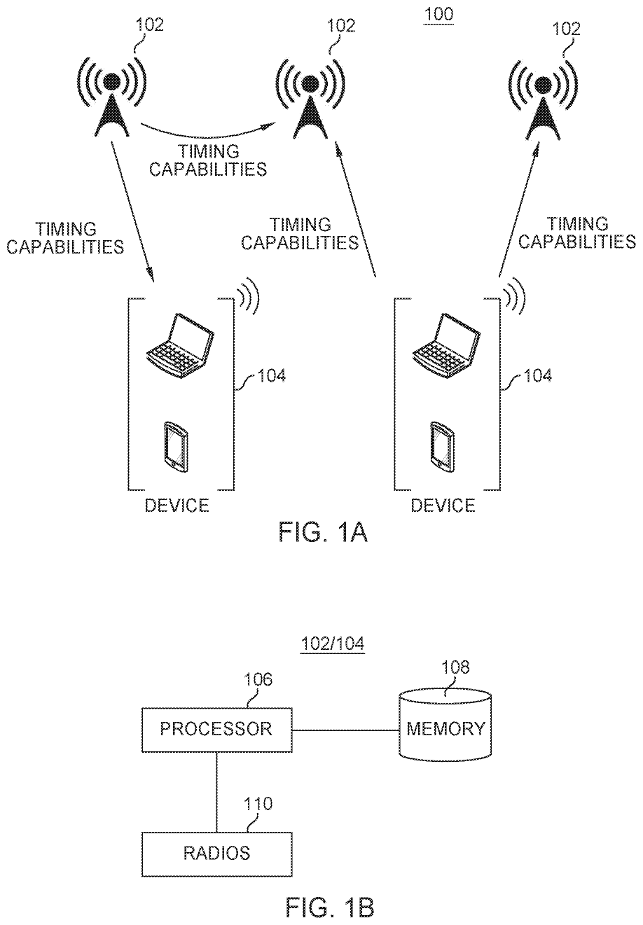

FIG. 1A illustrates an example system 100. As seen in FIG. 1A, the system 100 includes one or more access points 102 and one or more devices 104. Generally, the devices 104 connect to an access point 102. The access point 102 provides network coverage for the system 100. The access point 102 communicates messages to the devices 104 and directs messages from the devices 104 towards their destination.

The access point 102 facilitates wireless communication (e.g., WiFi communication) in the system 100. One or more devices 104 may connect to the access point 102. The access point 102 may then facilitate wireless communication for the connected devices 104. For example, the access point 102 may transmit messages to a connected device 104. As another example, the access point 102 may receive messages transmitted by the device 104. The access point 102 may then direct that message towards its intended destination.

The device 104 may be any suitable device that wirelessly connects to the access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

The access points 102 and the devices 104 may use certain techniques to synchronize their internal clocks. These techniques may be classified as location-based techniques or time-sync based techniques. For example, the access points 102 and the devices 104 may use FTM and/or UWB to synchronize their internal clocks. The access points 102 and the devices 104 may signal to each other which technique is used so that other access points 102 and devices 104 may tune for the used technique and understand how to initiate sessions with the used technique.

Generally, the access points 102 and devices 104 use a modified time advertisement element format (e.g., specified in IEEE Standard 802.11-2020 9.4.2.60) to signal their timing capabilities (e.g., the timing technique used by the access points 102 and devices 104 and/or the timing accuracy provided by the access points 102 and devices 104) to other components of the system. A message using this modified format includes a time value that is expressed using two sets of bits. The first set of bits (e.g., sixteen bits) indicates a number of seconds of the time value. The second set of bits (e.g., another sixteen bits) indicates fractional seconds of the time value. Using this format (e.g., which may be referred to as 32-bit unsigned short network time protocol (NTP) format), the message may indicate time values less than 300 picosecond (ps).

Additionally, the message includes a field (e.g., 4 bits) that indicates a timing accuracy range provided by the access points 102 and devices 104. For example, a value of this field may indicate that the time value is accurate within less than 1 nanosecond (ns). As another example, a value of this field may indicate that the time value is accurate within one ns to five ns or within five ns to ten ns. Any number of accuracy ranges may be mapped to the values for this field.

Using this process, an access point 102 or device 104 may determine the timing capabilities of other access points 102 or devices 104 in the system 100. Using this information, the access point 102 or device 104 may also determine how to initiate sessions with the other access points 102 or devices 104 to perform timing processes (e.g., synchronization).

FIG. 1B illustrates an example access point 102 or device 104 in the system 100 of FIG. 1A. As seen in FIG. 1B, the access point 102 or device 104 includes a processor 106, a memory 108, and one or more radios 110.

The processor 106 is any electronic circuitry, including, but not limited to one or a combination of microprocessors, microcontrollers, application specific integrated circuits (ASIC), application specific instruction set processor (ASIP), and/or state machines, that communicatively couples to the memory 108 and controls the operation of the access point 102 and/or device 104. The processor 106 may be 8-bit, 16-bit, 32-bit, 64-bit or of any other suitable architecture. The processor 106 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 106 may include other hardware that operates software to control and process information. The processor 106 executes software stored on the memory 108 to perform any of the functions described herein. The processor 106 controls the operation and administration of the access point 102 and/or device 104 by processing information (e.g., information received from the memory 108 and radios 110). The processor 106 is not limited to a single processing device and may encompass multiple processing devices contained in the same device or computer or distributed across multiple devices or computers. The processor 106 is considered to perform a set of functions or actions if the multiple processing devices collectively perform the set of functions or actions, even if different processing devices perform different functions or actions in the set.

The memory 108 may store, either permanently or temporarily, data, operational software, or other information for the processor 106. The memory 108 may include any one or a combination of volatile or non-volatile local or remote devices suitable for storing information. For example, the memory 108 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 108, a disk, a CD, or a flash drive. In particular embodiments, the software may include an application executable by the processor 106 to perform one or more of the functions described herein. The memory 108 is not limited to a single memory and may encompass multiple memories contained in the same device or computer or distributed across multiple devices or computers. The memory 108 is considered to store a set of data, operational software, or information if the multiple memories collectively store the set of data, operational software, or information, even if different memories store different portions of the data, operational software, or information in the set.

The radios 110 may communicate messages or information using different communication technologies. For example, the access point 102 and/or device 104 may use one or more of the radios 110 for WiFi communications. The access point 102 and/or device 104 may use one or more of the radios 110 to transmit messages and one or more of the radios 110 to receive messages. The access point 102 and/or device 104 may include any number of radios 110 to communicate using any number of communication technologies.

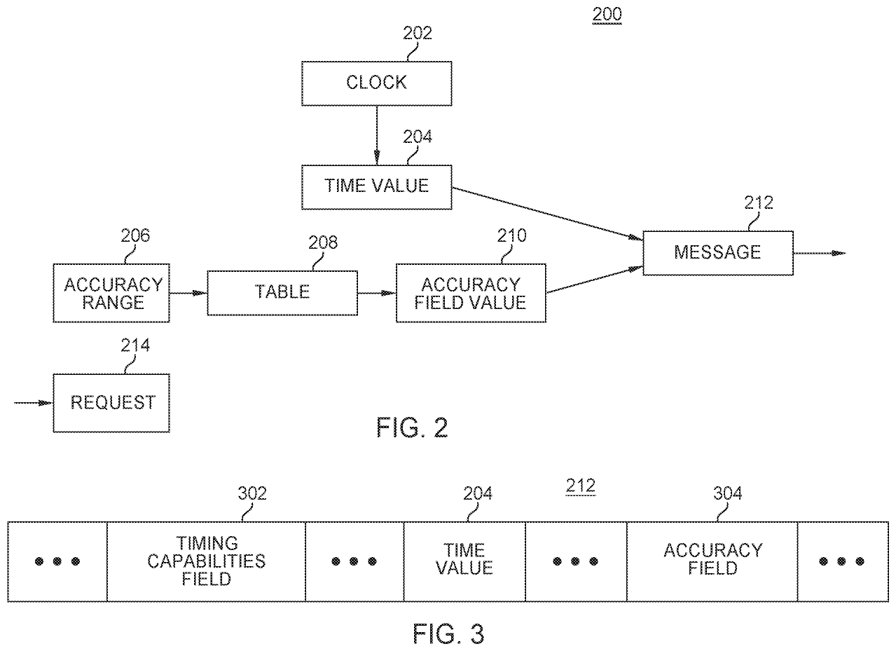

FIG. 2 illustrates an example operation 200 performed by the system 100 of FIG. 1A. Generally, a device (e.g., an access point 102 or device 104) in the system 100 performs the operation 200. By performing the operation 200, the device generates and communicates a message that indicates a time value and a timing accuracy range provided by the device.

As seen in FIG. 2, the device implements a clock 202. The device may use the clock 202 to determine a time value 204. For example, the device may use the clock 202 as a timer. The device may start the clock 202 upon an initial trigger. When another trigger occurs, the device may read the time value 204 from the clock 202. The time value 204 may thus reflect a period of time that elapsed since the initial trigger. As another example, the clock 202 may track the time, and the device may read the time directly from the clock 202 (akin to a timestamp). The device may determine a difference between two different times to determine the time value 204. For example, the device may transmit a message and read the time from the clock 202. The device may wait to receive a response to the message. When the response is received, the device may read the time from the clock 202. The difference between these two times may be the time value 204 that indicates how long it took for the device to receive a response to a transmitted message.

The device may also determine an accuracy range 206 for the device or the clock 202. The accuracy range 206 may indicate how accurate the time value 204 produced by the clock 202 is. As a result, the accuracy range 206 indicates a time accuracy provided by the device or the clock 202. The accuracy range 206 may indicate a range of times that indicates a limit on the error within the time value 204 produced using the clock 202. For example, if the accuracy range 206 indicates a time range from five ns to ten ns, then the time value 204 produced by the clock 202 may include an error that is between five ns to ten ns.

The device may reference a table 208 with the accuracy range 206 to determine an accuracy field value 210. For example, the table 208 may map different accuracy field values 210 to different accuracy ranges 206. The device may then use the table 208 to determine the accuracy field value 210 that is mapped to the accuracy range 206 for the device or the clock 202. The device may then retrieve the accuracy field value 210 from the table 208.

In some embodiments, the device determines the possible error in the time value 204 by analyzing the clock cycle or frequency of the clock 202. For example, the potential error may be limited by the amount of time that passes between clock cycles or half clock cycles of the clock 202. The device then determines into which accuracy range in the table 208 the potential error falls. The device then retrieves from the table 208 the accuracy field value 210 for the determined accuracy range. In this manner, the device determines the accuracy field value 210 for the potential error in the clock 202.

The device generates a message 212 (e.g., a time advertisement element) that includes the time value 204 and the accuracy field value 210. For example, the message 212 may use two sets of bits to record the time value 204. The first set of bits may indicate the number of seconds indicated by the time value 204. The second set of bits may be used to indicate fractional seconds of the time value 204. In some embodiments, the device uses sixteen bits for the first set of bits and sixteen bits for the second set of bits, which allows the device to record time values 204 that are less than 300 ps. As another example, the device may include the accuracy field value 210 in the message 212 to indicate the timing accuracy provided by the device or the clock 202. The device may then transmit the message 212 to other devices in the network to advertise the timing provided by the device. For example, the message 212 may indicate the timing accuracy provided by the device and how the time value 204 is specified in the message 212. Other devices on the network may then understand the timing capabilities of the device, which may be useful in synchronization processes. For example, this information may help the network determine whether the clock 202 should be used as a master clock during a synchronization process. As another example, this information may help the network determine whether the clock 202 or the device is capable of synchronizing to certain degrees of precision or accuracy.

In some embodiments, the device generates and transmits the message 212 in response to a request 214. For example, the device may receive the request 214 from another device (e.g., another access point 102 or device 104) in the system 100. The request 214 may request that the device advertise its timing capabilities to the rest of the network. In response, the device generates and transmits the message 212 to other devices in the network to advertise the timing capabilities of the device.

FIG. 3 illustrates an example message 212 in the system 100 of FIG. 1A. As seen in FIG. 3, the message 212 includes a timing capabilities field 302, the time value 204, and an accuracy field 304. The message 212 may include other fields that include other information.

The timing capabilities field 302 may include a number of bits that indicate how the time value 204 is specified. For example, the timing capabilities field 302 may include a value (e.g., the value three) to indicate that the time value 204 is specified using two sets of bits (e.g., two sets of sixteen bits). The first set of bits may specify the number of seconds in the time value 204, and the second set of bits may specify fractional seconds of the time value 204. When a receiving device in the system 100 receives the message 212, the receiving device may analyze the timing capabilities field 302 to understand how the time value 204 is specified in the message 212. The receiving device may then understand how to evaluate the bits that form the time value 204 in the message 212.

The accuracy field 304 may indicate the accuracy field value 210 (e.g., using four bits). As a result, the accuracy field 304 may indicate the timing accuracy range 206 provided by the device or the clock 202. As discussed previously, the accuracy field value 210 in the accuracy field 304 may be a number of bits that indicate the accuracy range 206 provided by the device for the clock 202. Thus, the accuracy field 304 may indicate an amount of error in the time value 204 provided by the device using the clock 202.

FIG. 4 illustrates an example time value 204 in the system 100 of FIG. 1A. As seen in FIG. 4, the time value 204 may be indicated using a set of seconds bits 402 and a set of fractional seconds bits 404. In some embodiments, each of the bits 402 and the bits 404 may include sixteen bits, which may be referred to as 32-bit unsigned short NTP format. Generally, the seconds bits 402 may indicate a number of seconds in the time value 204, and the fractional seconds bits 404 may indicate the fractional seconds in the time value 204. In some embodiments, the fractional seconds bits 404 may allow the device to indicate the time value 204 with a precision smaller than 300 ps. By specifying the time value 204 using the format shown in FIG. 4, the device may specify the time value 204 with greater amounts of precision relative to existing devices and networks.

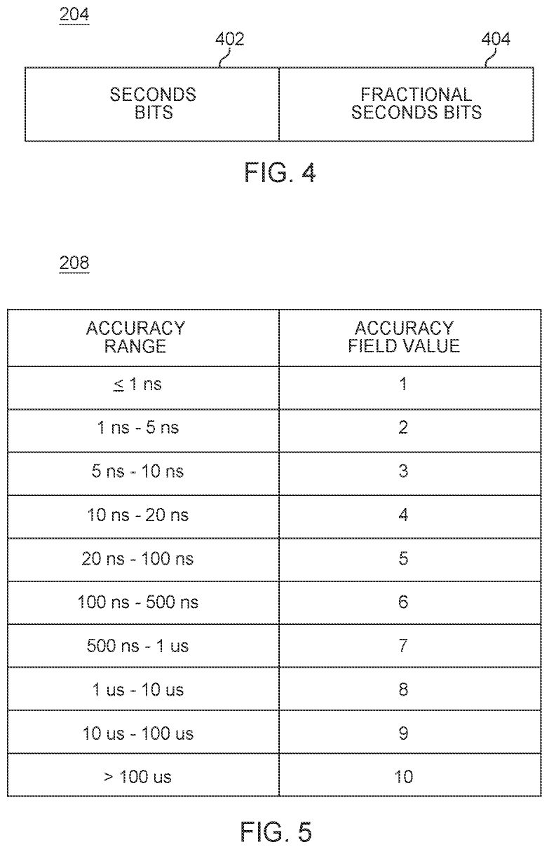

FIG. 5 illustrates an example table 208 in the system 100 of FIG. 1. As seen in FIG. 5, the table 208 maps accuracy ranges to accuracy field values. The table 208 may include any number of accuracy ranges and any number of accuracy field values. In the example of FIG. 5, the table 208 indicates that an accuracy range of less than one ns has an accuracy field value of one. An accuracy range between one ns and five ns has an accuracy field value of two. An accuracy range from five ns to ten ns has an accuracy field value of three. An accuracy range from ten ns to twenty ns has an accuracy field value of four. An accuracy range of twenty ns to 100 ns has an accuracy field value of five. An accuracy range from 100 ns to 500 ns has an accuracy field value of six. An accuracy range of 500 ns to one us has an accuracy field value of seven. An accuracy range of one us to ten us has an accuracy field value of eight. An accuracy range from ten us to 100 us has an accuracy field value of nine. An accuracy range greater than 100 us has an accuracy field value of ten.

The device may reference the table 208 using a determined accuracy range for the device to determine an accuracy field value for the determined accuracy range. For example, if the device determines that a determined time value has an accuracy within 25 ns, the device may determine an accuracy field value of five, because 25 ns falls within the 20 ns to 100 ns range. The device may then include the accuracy field value of five in the message 212 to advertise the accuracy range for the device. As another example, the device may analyze characteristics of the clock (e.g., the frequency or cycle of the clock) and/or characteristics of the device and network (e.g., memory and processor resources, channel state information, congestion, latency, interference, etc.) to determine the potential error in a time value determined using the clock. The device may then determine into which accuracy range in the table 208 the potential error falls. The device then retrieves the accuracy field value for that accuracy range from the table 208.

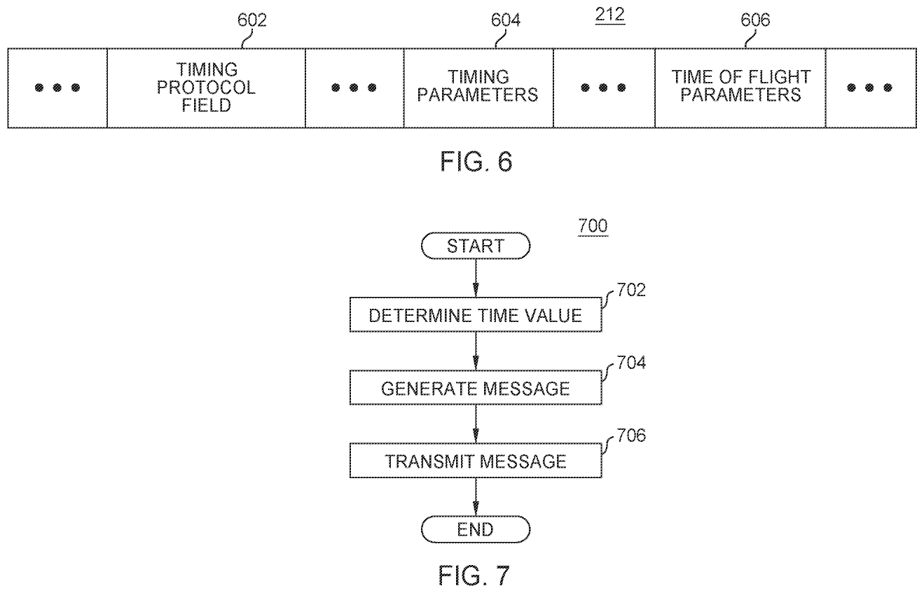

FIG. 6 illustrates an example message 212 in the system 100 of FIG. 1A. Generally, FIG. 6 shows other fields or components of the message 212. These fields or components may be in addition to the fields of the message 212 shown in FIG. 3. As seen in FIG. 6, the message 212 includes a timing protocol field 602, timing parameters 604, and time of flight parameters 606. The message 212 may include other fields and components not shown in FIG. 6.

The device may use the timing protocol field 602 to indicate various timing protocols or techniques that are implemented by the device. For example, the device may use the timing protocol field 602 to indicate whether the device performs FTM or UWB. The device may reference a table that maps various timing protocols and techniques to bit values. The device may use the table to determine the bit values that indicate the timing protocols and techniques implemented by the device. The device may then include those bit values into the timing protocol field 602. When another device receives the message 212, the other device may analyze the timing protocol field 602 to understand the timing protocols implemented by the device. The other device may then understand how to initiate sessions with the device according to the timing protocols and techniques implemented by the device.

The timing parameter 604 may indicate parameters that are used when performing timing using or with the device. For example, the timing parameter 604 may indicate parameters such as number of sequences, repetitions, number of chirps per burst, etc. The device may reference a table that maps certain timing parameters to bit values. The device may select the bit values from the table for the timing parameters 604 that the device includes in the message 212. The device may then include the bit values into the message 212 to indicate the timing parameters 604. When a receiving device receives the message 212, the receiving device may analyze the bit values in the message 212 to understand the timing parameters 604 that the device uses when performing timing.

The time of flight parameter 606 may indicate parameters that should be used during a time of flight measurement. The device may also use the time of flight parameters 606 to specify the parameters that the device uses during the time of flight measurement. For example, the time of flight parameters 606 may indicate a desired precision or accuracy of a time of flight measurement. Additionally, the time of flight parameters 606 may indicate a number of repetitions that a time of flight measurement should be taken. The device may perform a time of flight measurement to determine an amount of time that it takes for a message transmitted by the device to reach a receiving device. For example, the device may record the time using the clock 202 when the device transmits a message. When the receiving device receives the message, the receiving device may record the time of the clock of the receiving device. The receiving device may then transmit a response back to the device. The response may include the time from the clock of the receiving device. When the device receives the response, the device may determine the difference between the time when the message was transmitted and the time indicated in the response. The device may use this difference as the time of flight.

In some embodiments, the device may transmit the message 212 that includes the timing protocol field 602, the timing parameter 604, and/or the time of flight parameter 606. A receiving device may receive the message 212 and analyze the timing protocol field 602, timing parameter 604, and time of flight parameters 606 to understand how to request the device to perform certain timing techniques or protocols. The receiving device may communicate a request to the device to request that the device perform a particular timing protocol or technique with certain timing parameters or time of flight parameters. The device may receive the request and perform the requested timing protocol or technique according to any indicated parameters. In this manner, the device advertises the timing capabilities of the device to other devices and receives requests from those other devices.

FIG. 7 is a flowchart of an example method performed by the system 100 of FIG. 1A. In particular embodiments, a device (e.g., an access point 102 or device 104) performs the method 700. By performing the method 700, the device advertises its timing capabilities to other devices in the system 100.

In block 702, the device determines a time value 204. The device may implement an internal clock 202 that the device uses to determine the time value 204. For example, the time value 204 may be read from the clock 202. As another example, the time value 204 may be a difference between two different time readings from the clock 202.

In block 704, the device generates a message 212. The message 212 may include the time value 204. The device may use two sets of bits to indicate the time value 204 in the message 212. The first set of bits may be used to indicate the number of seconds in the time value 204, and the second set of bits may be used to indicate fractional seconds of the time value 204. In some embodiments, the second set of bits may allow the device to specify the time value 204 within a precision of 300 picoseconds.

In certain embodiments, the device also determines an accuracy range 206 for the device or the clock 202. The device also includes the accuracy range 206 in the message 212. In some instances, the device may use an accuracy field value 210 to indicate the accuracy range 206. The accuracy field value 210 may be a bit value that indicates the accuracy range 206. The device may determine the accuracy field value 210 using the table 208 that maps accuracy ranges 206 to accuracy field values 210. The accuracy range 206 may indicate a time range into which a potential error in the time value 204 falls. For example, the device may determine the potential error for the clock 202 by analyzing a characteristic of the clock 202 (e.g., frequency or duty cycle) or a characteristic of the device or network (e.g., memory and processor resources, channel state information, congestion, latency, interference, etc.). The device may then determine which accuracy range 206 indicated in the table 208 encompasses the potential error. The device then retrieves the accuracy field value 210 from the table 208 for the determined accuracy range 206. The device may include the accuracy field value 210 or the accuracy range 206 in the message 212.

In block 706, the device transmits the message 212 to other devices in the system 100. The message 212 may advertise the timing capabilities of the device to other devices in the system 100. In some embodiments, the message 212 may be a time advertisement element.

In summary, the devices (e.g., mobile devices 104 and access points 102) in the system 100 can signal their timing capabilities. Generally, each device may use an internal clock to determine a time value 204 within a certain accuracy range 206. The device may then generate a message 212 to report the time value 204 and/or the accuracy range 206. The message 212 may use set of bits to indicate the seconds of the time value 204 and another set of bits to indicate fractions of seconds of the time value 204. The device may then transmit the message 212 to let other devices in the network now of the device's timing capabilities.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An apparatus comprising:
one or more memories; and
one or more processors communicatively coupled to the one or more memories, a combination of the one or more processors configured to:
determine a time value;
generate a message comprising:
a first field using a first set of bits to indicate seconds of the time value and a second set of bits to indicate fractions of seconds of the time value; and
a second field indicating an accuracy range of the determined time value; and
wirelessly transmit the message.

2. The apparatus of claim 1, wherein:
the first set of bits comprises sixteen bits;
the second set of bits comprises sixteen bits; and
the second field comprises four bits.

3. The apparatus of claim 1, wherein the combination of the one or more processors is further configured to determine a timing protocol implemented by the apparatus, and wherein the message further comprises a third field indicating the timing protocol.

4. The apparatus of claim 3, wherein the combination of the one or more processors is further configured to:
reference a table to determine a bit value indicating the timing protocol; and
add the bit value to the third field.

5. The apparatus of claim 1, wherein the combination of the one or more processors is further configured to determine a timing parameter, and wherein the message further comprises a third field indicating the timing parameter.

6. The apparatus of claim 5, wherein the combination of the one or more processors is further configured to:
reference a table to determine a bit value indicating the timing parameter; and
add the bit value to the third field.

7. The apparatus of claim 1, wherein the message further comprises a third field indicating time of flight parameters.

8. The apparatus of claim 1, wherein the combination of the one or more processors is further configured to receive a request to advertise timing capabilities and wherein generating the message is in response to the request.

9. A method comprising:
determining a time value;
generating a message comprising:
a first field using a first set of bits to indicate seconds of the time value and a second set of bits to indicate fractions of seconds of the time value; and
a second field indicating an accuracy range of the determined time value; and
wirelessly transmitting the message.

10. The method of claim 9, wherein:
the first set of bits comprises sixteen bits;
the second set of bits comprises sixteen bits; and
the second field comprises four bits.

11. The method of claim 9, further comprising determining a timing protocol implemented by the method, and wherein the message further comprises a third field indicating the timing protocol.

12. The method of claim 11, further comprising:
referencing a table to determine a bit value indicating the timing protocol; and
adding the bit value to the third field.

13. The method of claim 9, further comprising determining a timing parameter, and wherein the message further comprises a third field indicating the timing parameter.

14. The method of claim 13, further comprising:
referencing a table to determine a bit value indicating the timing parameter; and
adding the bit value to the third field.

15. The method of claim 9, wherein the message further comprises a third field indicating time of flight parameters.

16. The method of claim 9, further comprising receiving a request to advertise timing capabilities, wherein generating the message is in response to the request.

17. An apparatus comprising:
one or more memories; and
one or more processors communicatively coupled to the one or more memories, a combination of the one or more processors configured to:
determine a time value;
determine an accuracy range for the time value;
determine, based on a table, an accuracy field value for the accuracy range;
generate a message comprising:
a first set of bits and a second set of bits indicating the time value;
a timing capabilities field value indicating that the first set of bits indicates seconds of the time value and that the second set of bits indicates fractions of seconds of the time value; and
the accuracy field value; and
wirelessly transmit the message.

18. The apparatus of claim 17, wherein:
the first set of bits comprises sixteen bits;
the second set of bits comprises sixteen bits; and
the accuracy field value comprises four bits.

19. The apparatus of claim 17, wherein the combination of the one or more processors is further configured to determine a timing protocol implemented by the apparatus, and wherein the message further comprises a field indicating the timing protocol.

20. The apparatus of claim 17, wherein the combination of the one or more processors is further configured to determine a timing parameter, and wherein the message further comprises a field indicating the timing parameter.
